(19) United States
(12) Patent Application Publication
(10) Pub. No.: US 2003/0020812 A1
(43) Pub. Date: Jan. 30, 2003

(54) Smart sensors for automobiles

(75) Inventors: Srinivas Gutta, Buchanan, NY (US); Miroslav Trajkovic, Ossining, NY (US); Antonio J. Colmenarez, Peekskill, NY (US)

Correspondence Address: Corporate Patent Counsel:, US Philips Corporation, 580 White Plains Road, Tarrytown, NY, 10590, US

(73) Assignee: Philips Electronics North America Corp.

(21) Appl. No.: 09/916,403

(22) Filed: Jul. 27, 2001

(51) Int. Cl. H04N 7/18

(52) U.S. Cl. 348/148; 348/159

(57) ABSTRACT

A system and method for detecting and recording an image of an impact to an object. The system comprises a sensor located to detect an impact at a corresponding surface region of the object and provide an output in response to detection of such an impact. The system further comprises an optical device having a field of view. The space adjacent the surface region corresponding to the sensor is located within the field of view of the optical device. The output provided by the sensor in response to detection of an impact initiates image capture by the optical device of the space adjacent the surface region corresponding to the sensor.

### FIELD OF THE INVENTION

The invention relates to automobiles and, in particular, to a system and method for detecting and recording images following an impact with the automobile.

### BACKGROUND OF THE INVENTION

Most owners of automobiles are well acquainted with the experience of returning to their car when parked in a public space (such as a parking lot, roadside, garage, etc.) and finding a dent (including a small dent, commonly referred to as a “ding”) or scratch on the automobile body. The sources of such dents or scratches are often the carelessness of another driver. The other driver may hit the car while parking, or when opening the door. In addition, items being removed from or placed into an adjacent car may impact the parked car, leaving dents, dings and/or scratches. Often, the driver or person who damages the parked car simply leaves the scene, leaving the owner to repair the damage.

In addition, a car that is parked along a public roadway that is hit by a passing car may suffer more serious damage than a small dent, ding or scratch that typically results from an impact while another car is parking. Once again, it is not uncommon for the driver or person to leave the scene, leaving the owner to fix the damage. This can often be a substantial amount of money. If the owner makes an insurance claim for the damage, there is often a substantial deductible and simply making the claim can lead to an increase in the owner's insurance premium.

Also, there are occasions where a car will be deliberately damaged by a vandal. For example, a car may be damaged by a vandal scratching the paint with a key (“keying”). The cost of repairing the intentional damage is often substantial.

### SUMMARY OF THE INVENTION

It is thus an objective of the invention to provide a system and method for deterring damage to an automobile. It is also an objective of the invention to provide an owner of a damaged automobile with an image of the person or car that damages the automobile.

Accordingly, the invention provides a system and method for detecting and recording an image of an impact to an object. The system comprises a sensor located to detect an impact at a corresponding surface region of the object and provide an output in response to detection of such an impact. The system further comprises an optical device having a field of view. The space adjacent the surface region corresponding to the sensor is located within the field of view of the optical device. The output provided by the sensor in response to detection of an impact initiates image capture by the optical device of the space adjacent the surface region corresponding to the sensor.

The system may further comprise a plurality of sensors each located to detect an impact at a corresponding surface region of the object and provide an output in response to detection of such an impact. The space adjacent the surface region corresponding to each of the plurality of sensors is located within the field of view of the optical device. The output provided in response to detection of an impact by one of the plurality of sensors initiates image capture by the optical device of the space adjacent the surface region corresponding to all of the plurality of sensors, including the space adjacent the surface region corresponding to the one sensor detecting the impact.

In addition, where the system comprises a plurality of sensors each located to detect an impact at a corresponding surface region of the object and provide an output in response to detection of such an impact, the system may additionally comprises a plurality of optical devices. The space adjacent the surface region corresponding to each of the plurality of sensors is within the field of view of at least one of the plurality of optical devices. The output provided in response to detection of an impact by one of the plurality of sensors initiates image capture by the at least one optical device having within its field of view the space adjacent the surface region corresponding to the one sensor detecting the impact.

In each case, a control unit may receive the output provided by each sensor in response to detection of an impact. Upon receipt of the output provided by a sensor that detects an impact, the control unit initiates image capture by the optical device having within its field of view the space adjacent the surface region corresponding to the sensor detecting the impact.

The invention also comprises a method of detecting an impact to an object at an impact region. An impact to an object is first detected. In response to the detection of the impact, an output signal is generated. In response to generation of the output signal, an image capture of the impact to the object is initiated. The image capture is by an optical device having a field of view that includes the impact region.

### BRIEF DESCRIPTION OF THE DRAWINGS

FIG. 1 is a side view of an automobile that incorporates an embodiment of the invention;

FIG. 1a is a top view of the automobile of FIG. 1;

FIG. 2 is a representative drawing of the circuitry for the embodiment of FIGS. 1 and 1a;

FIG. 3 is a side view of an automobile that incorporates an alternative embodiment of the invention;

FIG. 3a is a top view of the automobile of FIG. 3; and

FIG. 4 is a representative drawing of the circuitry for the embodiment of FIGS. 3 and 3a.

### DETAILED DESCRIPTION

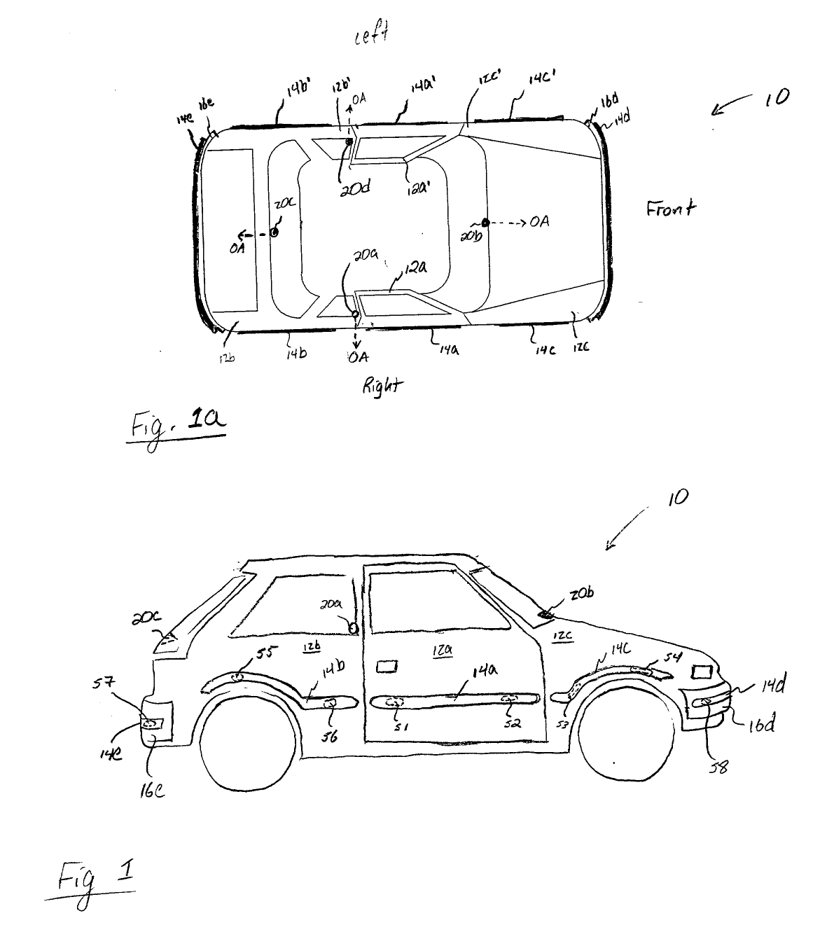

Referring to FIG. 1, an automobile 10 is shown that incorporates an embodiment of the invention. The side panels 12a-c of the automobile support protective vinyl strips 14a-c, respectively. Likewise front and rear bumpers 16d, 16e support protective vinyl strips 14d, 14e, respectively. The protective vinyl strips 14d, 14e of bumpers 16d, 16e extend the length of the bumpers. Likewise, as visible in FIG. 11a, the corresponding side panels 14a-c on the opposite side of the automobile also support protective vinyl strips 16a-c.

As shown in FIG. 1, the vinyl strips 14a-e each house a number of impact sensors, depicted in outline with reference numbers S1-S8. Sensors S1-58 are separated within each of the vinyl strips to detect impacts at different points on the strip, as described further below. Thus, vinyl strip 14a supports sensors S1, S2, vinyl strip 14b supports sensors S5, S6 and vinyl strip 14c supports sensors S3, S4. Sensor S7 is visible for vinyl strip 14e in FIG. 1, but it is understood that the vinyl strip 14e has a number of sensors along the length of vinyl strip 14e shown in FIG. 1a. Likewise, sensor S8 is visible for vinyl strip 14d in FIG. 1, but it is understood that the vinyl strip 14d has a number of sensors along the length of the vinyl strip 14d as shown in FIG. 1a.

Although not shown in FIG. 1a, vinyl strips 14a′-c′on the side panels 12a-c′ also incorporate sensors, similarly spaced to those depicted in FIG. 1 for vinyl strips 14a-c.

As shown in FIGS. 1 and 1a, cameras 20a-d are located on each of the sides and ends of the auto. Each camera 20a-d is pointed to capture images of the side of the automobile 10 on which it is located. Thus, camera 20a (located in the corner of the rear window of the auto) is pointed to capture images on the right-hand side of the car. Similarly, camera 20b located at the bottom of the front windshield is pointed to capture images toward the front of the car, camera 20c located at the bottom of the back window is pointed to capture images toward the back of the car, and camera 20d (see FIG. 1a) is pointed to capture images on the left-hand side of the car. The optic axes (OA) of cameras 20a-d are substantially level to the ground and normal to its respective side or end of the auto, as shown in FIG. 1a.

Cameras 20a-d have wide angle lenses which, preferably, capture images within 180° centered about the optic axis of the camera lens. Thus, camera 20a captures images over the entire right side of the auto 10, camera 20b captures images over the entire front of the auto 10, camera 20c captures images over the entire rear of the auto 10 and camera 20d captures images over the entire left side of the auto 10.

When one of the sensors detects an impact, a signal is generated to engage the camera corresponding to the side or end of the vehicle where the sensor is located. The camera corresponding to that side or end of the vehicle captures an image or a series of images, thereby recording an image or images of the vehicle, object andlor person that created the impact.

Sensors S1-S8 (and, as noted the other sensors that are included but not visible on the vinyl strips 14d, 14e and 14a′-c′ in FIGS. 1 and 1a) may be selected from many various types of mechanical, electrical and even optical or acoustic sensors that are well known in the art. For example, the sensors may be simple spring loaded electrical switches that make electrical contact when pressure is applied thereto. The sensors may likewise be, for example, transducers, mercury switches, pressure switches or piezoelectric elements. For each such exemplary sensor, an electrical signal is generated when a threshold impact is received at or near the sensor.

For example, a first terminal of a normally open switch of the sensor may be connected to a low voltage source; thus, when the switch is closed from an impact, a voltage signal is output at a second terminal of the switch. Similarly, for example, the continuity across the two terminals of the switch may be monitored to detect a change from infinite to zero effective resistance, thus indicating a closing of the switch due to an impact at or near the sensor. The detected change in resistance may be used directly to signal an impact, or a low voltage signal may be generated due to the change in resistance.

Likewise, for example, the sensors may be comprised of filaments that break when they receive an impact, thus generating an electrical signal from a lack of continuity. A change from zero to infinite effective resistance in a sensor would thus indicate an impact at or near the sensor. Again, the detected change in resistance may be used directly to signal an impact, or a low voltage signal may be generated due to the change in resistance.

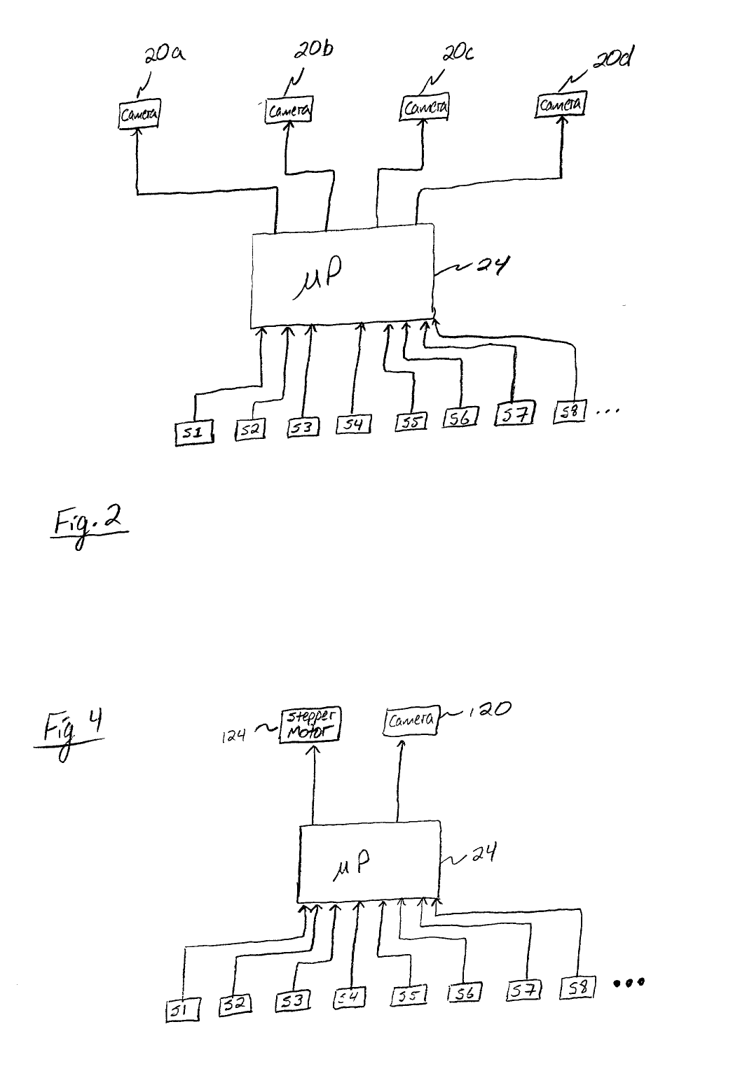

FIG. 2 is a representative diagram of an embodiment of the circuitry for the system of FIGS. 1 and 1a. Sensors S1, S2, . . . provide an input signal to microprocessor 24 upon an impact, as discussed above. Microprocessor 24 is programmed to generate an output signal to the camera 20a, 20b, 20c or 20d covering the side or end of the car on which the sensor providing the input is located. Thus, for example, if an impact is detected by sensor S6 in FIG. 1, the input signal provided by S1 to microprocessor 24 results in an output signal to camera 20a pointed at the right-hand side of the car. Camera 20a consequently captures an image (or a series of images) of the right-hand side of the auto 10. The images record the person, object and/or vehicle that creates the impact.

As noted above, it is preferable that the wide angle lenses of the cameras have a field of view of 180 degrees centered about the optical axis. Thus, camera 20a captures images along the entire right-hand side of the auto 10, camera 20b captures images along the entire front of the auto 10, camera 20c captures images along the entire rear of the auto 10 and camera 20d captures images along the entire left side of the auto 10. Microprocessor 24 is programmed so that an input from any sensor (S1-S6) due to an impact along the right hand side of the auto engages camera 20a, thus recording the impact-creating event; an input from any sensor (S8, and others not visible in FIG. 1 and 1a) due to an impact along the front of the auto 10 engages camera 20b, thus recording the impact-creating event; an input from any sensor (S7 and others not visible in FIGS. 1 and 1a) due to an impact along the back of the auto 10 engages camera 20c, thus recording the impact-creating event; and an input from any sensor along the left side of the auto 10 (not shown in FIGS. 1 and 1a) due to an impact engages camera 20d, thus recording the impact-creating event.

For certain corner regions of the auto 10, more than one camera may be used to capture an image of the region. For example, if the wide angle lenses of the cameras have a field of view of 180° centered about the optical axis, then it is seen from FIG. 1a that an impact along vinyl strip 14c may be recorded by both cameras 20a and 20b. Thus, microprocessor 24 may be programmed to initiate image capture by both cameras 20a and 20b when an impact is detected by sensor S3 and S4. The microprocessor 24 may be programmed so that two cameras covering an overlapping corner region are initiated when an impact is detected by a sensor in the overlapping region.

While four cameras are used in the embodiment of FIGS. 1, 1a and 2, more or less than four cameras may be used, provided that the cameras used may be strategically located so that the entire region surrounding the car is covered by the fields of view of the cameras and provided that microprocessor 24 is programmed so that the appropriate camera is engaged when a sensor indicates an impact in the camera's field of view.

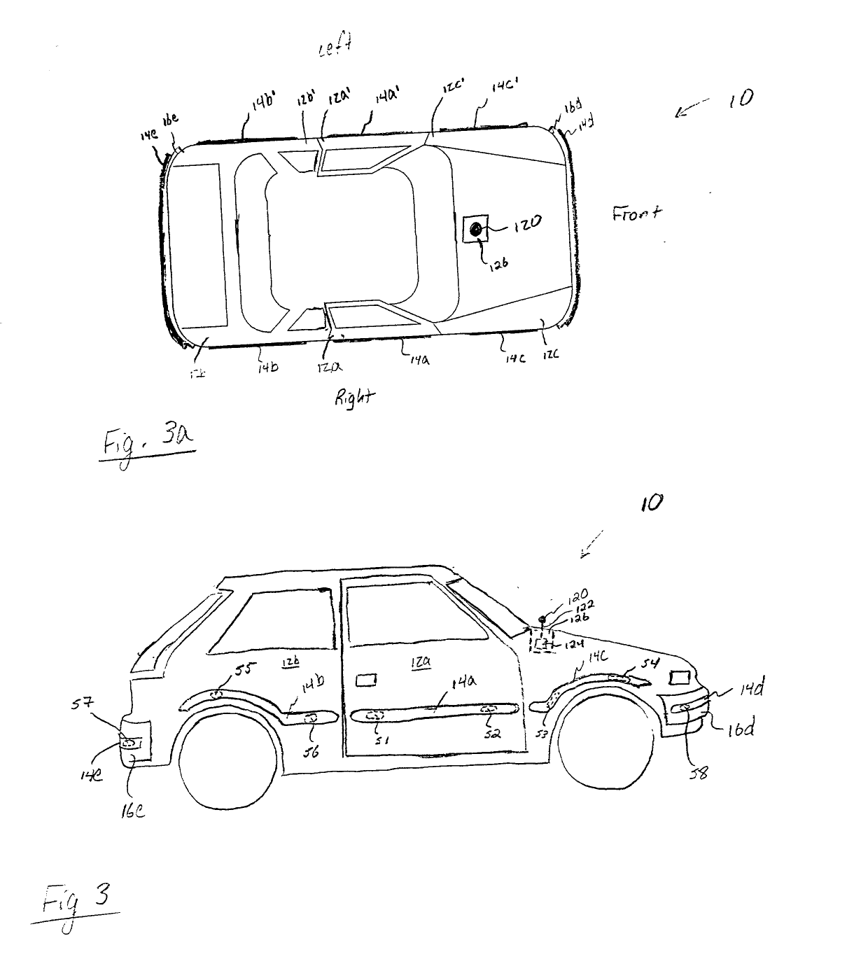

Thus, in another exemplary embodiment shown in FIGS. 3 and 3a, a single omnidirectional camera 120 may be used. An omnidirectional camera captures images over a 360° field of view and is therefore capable of capturing images around the entire auto. The omnidirectional camera 120 is housed at approximately the center of the hood adjacent the windshield. The camera 120 is shown supported by post 122 which interfaces with stepper motor 124. Stepper motor is housed within a compartment 126 located beneath the hood (within the engine compartment region).

Camera 120 also normally resides within compartment 126. FIG. 1 shows the camera 120 when it is positioned outside compartment 126 and in a position to capture images. When an impact is sensed, the stepper motor 124 moves the camera 120 from inside the compartment 126 so that it is positioned above the hood of the auto as shown. (The stepper motor 124 moves the camera 120 by translating post 122 with a gearing mechanism, by telescoping the post 122, or via any other well-known translation mechanism.) The camera 120 positioned as shown above the hood captures one or more images of the entire region surrounding the auto 10. (The region to the sides and rear of the auto 10 are captured by through the windows.) After the images are captured, the camera 120 is retracted by stepper motor 124 into compartment 126. A cover for compartment 126 that is flush with the hood may also be opened when the camera 120 is extended and closed when it is retracted.

FIG. 4 is a representative diagram of an embodiment of the circuitry for the system of FIGS. 3 and 3a. Sensors S1, S2, . . . provide an input signal to microprocessor 24 upon an impact, as discussed above. Microprocessor 24 is programmed to generate control output signals to stepper motor 124 and camera 120. When an impact is detected by any one of the sensors SS1, S2, microprocessor 124 controls stepper motor 124 so that camera 120 extends from the compartment 126 and above hood, as shown in FIG. 3. Once extended, microprocessor controls camera 120 to take one or more images of the region surrounding the car. As noted, since camera 120 is a omnidirectional camera, the image captured is of the entire region surrounding the auto 10, thus capturing the impact creating event. When the camera 120 finishes capturing the one or more images, the microprocessor controls stepper motor 124 to retract the camera into compartment 126.

The omnidirectional camera 120 of the embodiment of FIGS. 3, 3a and 4 may be replaced with a standard camera that has a more constrained field of view. In that case, the stepper motor 124 may additionally include a rotatable drive shaft that serves to rotate post 122 about its central axis. By rotating post 120, stepper motor 124 also rotates camera 120 so that the impact region lies within the field of view of the camera. Processor 24 may be programmed so that the rotation of the camera 120 is correlated to the region of the car for the particular sensor S1, S2, . . . that detects the impact. In addition, the support between the camera 120 and the post 120 may include a tilt mechanism that allows the camera 120 to be tilted toward the impact region, also based on control signals received from processor 24. The camera of this embodiment and others may also include auto-focus, automatic zoom and other like features so that the image captures the impact with the requisite clarity.

In both embodiments, namely the embodiment of FIGS. 1, 1a and 2 and the embodiment of FIGS. 3, 3a and 4, reference has been made to the captured “image” or “images” that are recorded by a camera after the impact event. It is understood that the “images” may be unprocessed image data (such as the data recorded in a CCD array), in which case they may be stored in memory for later image processing and reproduction. Alternatively, the images may be partly or wholly processed into a reproducible image format and stored in memory. The images may be stored in a memory associated with the camera, which may be a standard digital camera having a CCD array. Alternatively, the image (either unprocessed or processed image data) may be transferred by the microprocessor 24 to a centralized memory, which may be associated with microprocessor 24. In addition, the microprocessor 24 may support some or all image processing relating to the captured images. Thus, the cameras in both embodiments may be comprised of the optical elements and a CCD array, with no image processing components.

In addition, the images captured may be transmitted to a display device that is accessible to the owner of the auto 10. The image data may be pre-processed prior to transmission (either in the camera and/or the microprocessor 24), or some or all of the of the image data processing may take place in the display device after transmission. For example, microprocessor 24 may transfer an image captured after an impact to a wireless transmitter, which transmits the image to the display on the owner's cell phone or “smart key”. The cell phone, smart key or other like device is comprised of an antenna, receiver, processor and display screen, which serves to receive, process and display the image of the impact to the owner. The owner can view the impact causing event on the display screen and take appropriate action. A smart key and other like devices that may be used to display the impact causing event are described in U.S. patent application Ser. No. 09/728,054 entitled “Method And Apparatus For The Display Of Alarm Information On A Portable Device” for Miroslav Trajkovic and Srinivas Gutta, filed Dec. 1, 2000 (Docket No. US000350), the contents of which are hereby incorporated by reference herein.

Returning briefly to the embodiment of FIGS. 3, 3a and 4, it was noted that after a sensor S1, S2, . . . , sends a signal to microprocessor 24, omnidirectional camera 120 captures one or more images of the entire region surrounding the auto 10. Microprocessor 24 may also be programmed to corrolate the particular region within the 360° field of view based on the sensor that detects the impact. For example, in FIG. 3, if sensor S8 detects the impact, then microprocessor 24 is programmed to note that the portion of the image corresponding to the front, right-hand portion of the auto 10 will record the impact. Thus, when processing the 360° image, the image processing may focus on the particular portion of the image where the impact is detected. The image data for the impact region alone may also be stored in memory and/or output on the display device, as discussed above.

It is further noted that the sensors S1, S2, . . . may be selected or adjusted so that the impact must have a threshold level before a signal indicating an impact is generated. Alternatively, the magnitude of the electrical signal generated by the sensor may be a function of the magnitude of the impact (as in a piezoelectric sensor, for example). In that case, a threshold electrical signal may be required before the camera captures an image.

In addition, if two or more sensors detect the same impact or multiple impacts substantially simultaneously and more than one camera covers the regions corresponding to the detecting sensors, then the cameras covering the different regions are initiated. If one camera covers the region corresponding to all of the detecting sensors, then only one camera is initiated.

Other sensors may also be used to detect an impact. For example, infrared or acoustic sensors may be used. The infrared sensor may detect not only an impact to the auto 10, but may also initiate a camera when a person or object is within a certain distance of the auto.

The spacing and number of the sensors S1, S2, . . . shown in FIGS. 1 and 3 above are only representative. The sensors may be more or less numerous and may be spaced closer or further apart. The number and position may depend on the type of sensor, sensitivity of the sensor, how it is mounted, etc. In general, it is preferable to use a sensor that will detect an impact over a portion of the auto, for example, so that it detects impacts over a portion of the auto that overlaps with sensors providing coverage for adjacent portions. This provides detection of an impact over contiguous portions of the auto. The sensors may be located to provide coverage over those portions of the auto that are most likely to suffer damage. In addition, more sensors may be located in a region that is more likely to suffer impact, such as a door or bumper.

As noted, it is preferable that the sensors detect an impact for a portion of the auto. This may be provided by the sensitivity of the sensor itself and/or how the sensor is mounted. For example, in the above-described embodiments, the sensors are mounted in vinyl strips surrounding the auto. For an impact that does not directly fall upon a sensor, the vinyl strip serves to translate force of the impact to one or more nearby sensors. The sensor, of course, does not have to be located within or upon vinyl strips. They may be mounted on the inside of the side panels and bumpers of the auto, for example. The force of an impact adjacent to a sensor will likewise translate within the structure of the panel or bumper to the nearby sensor. The sensors may alternatively be located within or underneath ornamental stripes that extend the length of the auto. This is especially suited for sensors comprised of piezoelectric strips, or wires that break upon impact.

For sensors that must be replaced after an impact, it is desirable to mount them in an accessible manner and in a manner that provides for easy replacement.

In addition, although a microprocessor is depicted in the above-described embodiments, the output of each sensor may alternatively be connected directly to the appropriate camera. When an impact is detected by a sensor, the corresponding camera may be directly initiated.

Although illustrative embodiments of the present invention have been described herein with reference to the accompanying drawings, it is to be understood that the invention is not limited to those precise embodiments, but rather it is intended that the scope of the invention is as defined by the scope of the appended claims. For example, the invention may be readily adapted to detect impacts in objects other than automobiles.

What is claimed is:

1. A system for detecting and recording an image of an impact to an object, the system comprising: a) a sensor located to detect an impact at a corresponding surface region of the object and provide an output in response to detection of such an impact and b) an optical device having a field of view, the space adjacent the surface region corresponding to the sensor located within the field of view of the optical device, wherein the output provided by the sensor in response to detection of an impact initiates image capture by the optical device of the space adjacent the surface region corresponding to the sensor.

2. The system as in claim 1, wherein the object is an automobile.

3. The system as in claim 1, wherein the optical device is a camera.

4. The system as in claim 1, further comprising a control unit that receives the output provided by the sensor in response to detection of an impact, wherein the control unit, upon receipt of the output provided by the sensor when an impact is detected, initiates image capture by the optical device of the space adjacent the surface region corresponding to the sensor.

5. The system as in claim 1, wherein the sensor is one of an electrical, acoustic, piezoelectric, mercury and infrared switch.

6. The system as in claim 1, wherein the system comprises a plurality of sensors each located to detect an impact at a corresponding surface region of the object and provide an output in response to detection of such an impact.

7. The system as in claim 6, wherein the space adjacent the surface region corresponding to each of the plurality of sensors is within the field of view of the optical device, wherein the output provided in response to detection of an impact by one of the plurality of sensors initiates image capture by the optical device of the space adjacent the surface region corresponding to all of the plurality of sensors, including the space adjacent the surface region corresponding to the one sensor detecting the impact.

8. The system as in claim 7, wherein the optical devices are cameras.

9. The system as in claim 7, wherein the object is an automobile.

10. The system as in claim 7, further comprising a control unit that receives the output provided by each of the plurality of sensors in response to detection of an impact, wherein the control unit, upon receipt of the output provided by one of the plurality of sensors that detects an impact, initiates image capture by the optical device of the space adjacent the surface region corresponding to all of the plurality of sensors, including the space adjacent the surface region corresponding to the one sensor detecting the impact.

11. The system as in claim 6, wherein the system additionally comprises a plurality of optical devices, the space adjacent the surface region corresponding to each of the plurality of sensors being within the field of view of at least one of the plurality of optical devices, wherein the output provided in response to detection of an impact by one of the plurality of sensors initiates image capture by the at least one optical device having within its field of view the space adjacent the surface region corresponding to the one sensor detecting the impact.

12. The system as in claim 11, wherein the optical devices are cameras.

13. The system as in claim 11, wherein the object is an automobile.

14. The system as in claim 11, further comprising a control unit that receives the output provided by each of the plurality of sensors in response to detection of an impact, wherein the control unit, upon receipt of the output provided by one of the plurality of sensors that detects an impact, initiates image capture by the at least one optical device having within its field of view the space adjacent the surface region corresponding to the one sensor detecting the impact.

15. The system as in claim 1, wherein the optical device is movable to position the field of view of the optical device so that the space adjacent the surface region corresponding to the sensor is located within the field of view of the optical device.

16. A method of detecting an impact to an object at an impact region, comprising the steps of:
a) detecting an impact to an object;
b) generating an output signal in response to the detection of the impact;
c) initiating an image capture of the impact to the object in response to generation of the output signal of step b, the image capture being by an optical device having a field of view that includes the impact region.

17. The method of claim 16, wherein the output signal is used to determine one of a plurality of optical devices that is used to initiate the image capture of the impact, the one of the plurality of optical devices having a field of view that includes the impact region.

18. The method of claim 16, wherein the image captured is transmitted to a display device.
